(19) United States
(12) Patent Application Publication
(10) Pub. No.: US 2015/0114684 A1
(43) Pub. Date: Apr. 30, 2015

(54) SUPPORT INSULATOR ARRANGEMENT

(71) Applicant: SIEMENS AKTIENGESELLSCHAFT, MUENCHEN (DE)

(72) Inventors: Frank Ehrlich, Hohen Neuendorf (DE); Guenter Kaulfuss, Falkensee (DE); Peter Milewski, Berlin (DE); Thilo Nehring, Berlin (DE)

(21) Appl. No.: 14/364,769

(22) PCT Filed: Nov. 19, 2012
(86) PCT No.: PCT/EP2012/072988

§ 371 Date: Jun. 12, 2014

(30) Foreign Application Priority Data
Dec. 13, 2011 (DE) 102011088353.3

(51) Int. Cl. H01B 17/16; H01B 17/38

(52) U.S. Cl. CPC H01B 17/16; H01B 17/38
USPC 174/209

(57) ABSTRACT

A support insulator assembly has an electrically insulating body, a first support region and a second support region. The two support regions are spaced apart relative to one another by way of the insulator body. The first support region has an armature body, which is at least partially embedded in the insulator body.

The invention relates to a support insulator assembly having an electrically insulating insulating body and a first supporting region and a second supporting region, which are kept at a distance in relation to one another by the insulating body.

Such a support insulator assembly is known for example from the laid-open application DE 44 18 797 A1. The support insulator assembly has an electrically insulating insulating body and a first supporting region and a second supporting region. The two supporting regions are kept at a distance in relation to one another by the insulating body. The support insulator assembly is intended to provide electrically insulated support for subassemblies of an electrical high-voltage circuit breaker. Support insulator assemblies are used for the purpose of ensuring support and positioning of subassemblies. When a support insulator assembly is used in the high-voltage area, its insulating body in particular undergoes increased dielectric stress as a result of great differences in potential. Such stress may lead to a weakening of the structure of the insulating body. There is consequently the risk that, under sustained loading from electrical fields, the mechanical stability of the insulating body will be adversely affected, so that it can no longer fully perform its supporting and holding function and there may be mechanical problems with the known electrical high-voltage circuit breaker.

It is consequently an object of the invention to provide a support insulator assembly which on the one hand ensures sufficient electrical insulation resistance and on the other hand has sufficient mechanical strength for as long as possible.

According to the invention, the object is achieved in the case of a support insulator assembly of the type mentioned at the beginning by at least the first supporting region having a first armature body that is at least partially embedded in the insulating body.

A support insulator assembly serves for keeping at a distance and holding two subassemblies in relation to one another. The two subassemblies to be separated from one another may carry different electrical potentials. Thus, an electrical phase conductor may be supported on a supporting element with the support insulator assembly interposed and be positioned in relation thereto. Correspondingly, the insulating capacity of the insulating body between the two supporting regions must be great enough for there to be a sustained secure separation between the potentials of the subassemblies held on the supporting regions. By embedding a first armature body in the first supporting region, the insulating body is mechanically stabilized in the supporting region itself by the armature body. Furthermore, an armature body can have the effect of influencing an electrical field, so that for example it is homogenized. In this way, field strength peaks are reduced and aging of the insulating body by dielectric stress is limited. Correspondingly, the armature body may for example be a metallic cast body, for example a ferrous metal cast body or a nonferrous metal cast body. The armature body may have the same electrical potential as the subassembly held on the respective supporting region.

Embedding the armature body in the insulating body provides the possibility of allowing surface regions of the insulating body and the armature body to lie against one another and be connected for force transmission, in order to ensure a fixed-angle bond between the armature body and the insulating body. For example, a material bond may be provided between the insulating body and the armature body.

To achieve a material bond, the armature body may for example be adhesively bonded in a clearance of the insulating body, so that the armature body is at least partially embedded within the insulating body. However, it may also be provided that the armature body is at least partially encapsulated by the insulating body, so that there is a cast bond between the insulating body and the armature body. The armature body may be completely embedded in the insulating body, so that the armature body is surrounded on all sides by insulating material of the insulating body. The supporting region may for example be at least partially or completely formed by the armature body. Thus, for example, supporting areas may be provided on the support insulator assembly, in order to allow the subassemblies that are to be separated from one another, or at least one of these subassemblies, to lie against a respective supporting area. The subassembly to be held can be correspondingly connected to the supporting area, so that there is for example a fixed-angle or limitedly elastic bond between the support insulator assembly and the subassembly to be supported. A supporting region may for example have areas, bolts, threaded bores or semifinished forms that are suitable in some other way for connecting the subassembly to be held to the support insulator assembly. Thus, for example, the subassembly may be screwed in the supporting region or be fixed by pressing, welding, adhesive bonding, clamping, etc. The supporting region may also be partially or completely formed by the insulating body. It is particularly advantageous for a supporting region to be formed in a bond of the armature body and the insulating body.

A further advantageous configuration may provide that the second supporting region has a second armature body that is at least partially embedded in the insulating body.

Providing each of two supporting regions with an armature body makes it possible to configure the two supporting regions for example in an analogous way. It is thereby possible to connect the two subassemblies that are to be connected by way of the support insulator assembly to the support insulator assembly in a similar way. Depending on the intended position of the subassemblies to be supported with respect to one another, the supporting regions may lie differently aligned in relation to one another on the support insulator assembly. For example, the supporting regions may be arranged at ends of the electrically insulating body that are aligned oppositely from one another. The supporting regions may be arranged axially in line or be aligned tilted at an angle in relation to one another. This provides the possibility of realizing different variants for supporting the subassemblies on the support insulator assembly. When armature bodies are used on the first and second supporting regions, an electrical field can be influenced jointly by the armature bodies. It is consequently possible to achieve improved field control on the support insulator assembly.

A further advantageous configuration may be provided by an armature body having a main body in the form of at least one segment of a ring, in particular in the form of a full ring.

A main body of the armature body may advantageously have at least the form of a segment of a ring, in particular the form of a full ring. Of course, main bodies of the armature bodies of the first and second supporting regions may also be fashioned in relation to one another at least in a way similar to a segment or a full ring.

A ring structure of an armature body allows a curved body to be fashioned for the armature body, so that when the armature body is embedded in the insulating body there is an increased surface area, which is conducive to a bond between the armature body and the insulating body that is as fixed as possible in terms of its angle. Between the armature body and the insulating body, the area that can be used for force transmission is increased and loosening of the armature body on the insulating body is made more difficult. Furthermore, a portion of the armature body that is curved in the form of a ring makes it possible for the insulating body to be shaped in a correspondingly variable way. In particular when fashioning rotationally symmetrical insulating bodies, the armature body may be favorably embedded in a curved circumferential area of the insulating body. The ring may for example be fashioned as a toroid. On the armature body there may for example be three threaded bores, which serve for fixing a subassembly on the supporting region and are arranged such that they are distributed on an arc of a segment of the main body, so that a defined regular or isosceles triangle is formed, and consequently a simplified manner of fixing a subassembly on the supporting region at a fixed angle is obtained. In particular when a full ring is used for the armature body, holding forces can be introduced into the armature body and these holding forces can be introduced into the insulating body over a large surface area. In this case, a ring represents a construction that is particularly resistant to torsion and can be configured with a comparatively low mass. Consequently, an armature body brings about a mechanical stabilization of the support insulator assembly. Furthermore, fashioning the armature body at least as a partial ring, in particular as a full ring, provides a possibility of ensuring a dielectric shielding on the support insulator assembly. Thus, for example, a dielectric shielding of fastening means may be provided by the armature body. For example, bolts screwed into the armature body may be dielectrically shielded by the armature body. The region around the armature body, in particular the respective supporting region of the insulating body, is protected from inhomogeneous electrical fields, which could introduce electrical potentials that are excessive in places into the insulating body, so that the insulating body would undergo increased dielectric stress and premature aging. In particular, a full ring for the main body combines favorable mechanical properties with good homogenization or smoothing of an electrical field. A ring may have various cross sections of the ring, such as for example circular, oval or polygonally rounded cross sections.

A further advantageous configuration may provide that the armature body has at least one supporting area which is aligned transversely in relation to the ring axis of the main body, in particular perpendicularly, and passes through a surface of the insulating body.

Embedding of the armature body may take place on the one hand by it being arranged completely within the insulating body and displaying its mechanically stiffening, stabilizing effect there in the manner of reinforcement, and possibly additionally displaying a field-influencing effect. Furthermore, an armature body embedded in this way may serve for homogenizing electrical fields. If the armature body is then used for fashioning a supporting area that passes through a surface of the insulating body, on the support insulator assembly there can be formed a mechanically stable attachment point, at which for example components to be supported can be fixed. The supporting area of the armature body protects the insulating body from damage that could occur for example by materials that are harder than the insulating material of the insulating body being pressed against the insulating body. For example, pressing forces could scratch or otherwise damage the surface. The use of the supporting area of the armature body, which should preferably consist of a metallic material, offers a sufficiently resistant surface for bearing a subassembly to be held. A ring axis is an axis about which a main body in the form of a ring runs or which is enclosed by the main body. If the main body only represents a segment of a full ring, the position of the ring axis relates to a completed full ring. An alignment of the supporting area transversely in relation to the ring axis, in particular a perpendicular alignment in relation to the ring axis, of a supporting area that is in particular planar, makes it possible for the support insulator assembly to be used within a system of Cartesian coordinates. This allows the support insulator assembly also to be integrated in a modular manner in existing configurations.

The surface can in this case be passed through in such a way that the supporting area is almost flush with the surface of the insulating body without any gap and goes over into a surface of the insulating body virtually without any projection. However, it may also be provided that the supporting area is arranged on a shoulder of the armature body that keeps the supporting area at a distance from the surface of the insulating body, so that the supporting area protrudes beyond the surface of the insulating body. Such a configuration has the advantage that an additional distance is created between subassemblies lying against the supporting area and the insulating material of the insulating body, and in this way the risk of mechanical impairment of the insulating body is further reduced. A supporting area may also extend over various portions of the armature body. For example, the supporting area may be passed through by a shoulder.

Furthermore, it may be advantageously provided that the armature body has at least a first and a second attachment point, which are fixed at a fixed angle in relation to one another by the main body.

The use of a first and a second attachment point on the armature body makes it possible to introduce forces into the support insulator assembly over as large an area as possible. Fixing two attachment points at a fixed angle by way of the main body makes it possible to predetermine standardized positions for the fastening of a component to the support insulator assembly. Thus, the two attachment points may for example be kept at a specific distance from one another, any changing of this distance being prevented by the mechanically stabilizing main body. Bolts, threaded bores, etc. may be used for example as the attachment point. A connection of the attachment points by way of the main body also makes it possible to arrange attachment points on various supporting areas.

A further advantageous configuration may provide that the armature body has two supporting areas which pass independently of one another through a surface of the insulating body and are connected by the main body.

The first and second supporting areas may be respectively designed for receiving one or more attachment points. The bonding of the supporting areas by way of the main body allows them to be aligned at a fixed angle in relation to one another. Consequently, the positions of the attachment points are also fixed in relation to one another.

Two supporting areas which pass independently of one another through the surface make it possible to connect differently formed supporting areas by way of one and the same main body. The connection of the two supporting areas by way of the main body has the effect that the supporting areas are fixed in relation to one another, so that the supporting areas extend out from the surface of the insulating body in a fixed way. For example, it may be provided that the main body is a full ring, the supporting areas being respectively fashioned only as segments of a ring, so that transverse webs filled with insulating material respectively remain between the ring segments of the supporting areas. These transverse webs are dielectrically shielded by the supporting areas and by the armature body, whereby these regions are suitable for example for positioning discontinuities of the insulating body there. Such discontinuities may be for example flash, cast seams, etc. Correspondingly, these inhomogeneities on the insulating body need not be cleaned with particular care, since there is sufficient dielectric shielding by the supporting areas that are kept at a distance from one another and pass independently of one another through the insulating body. The transverse webs may be bridged by a portion of the main body that is in particular sheathed completely by insulating material, so that an improved dielectric shielding effect is possible.

It may also be advantageously provided that a supporting area corresponds at least to a sector of a circular ring, in particular a complete circular ring.

A sector of a circular ring or a complete circular ring allows attachment points arranged within the supporting areas to be distributed symmetrically in relation to a ring axis of the sector of the circular ring or of the complete circular ring. A number of attachment points, for example three, define a bearing position on the support insulator assembly for a subassembly to be supported. This bearing position can enforce a specific mounting position of the subassembly, so that quick, error-free mounting is possible.

It may be provided that a single supporting area is formed as a circular ring or as a portion of a circular ring. It may, however, also be provided that a number of segments, particularly that are kept at a distance from one another (while leaving transverse webs of insulating material of the insulating body), together make up a ring-shaped supporting area. Supporting areas may generally be formed advantageously as planar areas. In addition, however, the areas may also be non-planar, for example spherically curved, stepped or formed as the circumferential shell of a cylinder.

A further advantageous configuration may provide that a number of supporting areas lie within an enveloping contour of a circular ring.

Independently of the form of one or more supporting areas, the supporting areas may together lie within an enveloping contour of a circular ring. Consequently, there are a number of supporting areas in a supporting region, together lying within an overall circular ring. The individual supporting areas are in this case kept at a distance from one another however, so that each supporting area passes independently of another supporting area through a surface of the insulating body.

The transverse webs of the insulating body that remain between the supporting areas are filled with electrically insulating material, it being possible for a main body of an armature body to be embedded within the insulating body and it being possible for positions of a number of supporting areas to be fixed within the enveloping contour of a circular ring by way of the main body.

A further advantageous configuration may provide that the supporting areas lie at a distance from one another in a surface of the insulating body.

Supporting areas located on the support insulator assembly may lie at a distance from one another in a surface of the insulating body. For example, a number of supporting areas may together be arranged within one and the same supporting region. It may, however, also be provided that the supporting areas lie at a distance from one another in a surface of the insulating body with the supporting areas being respectively assigned to different supporting regions. Independently of the position of the supporting areas, there is in each case a sufficient electrically insulating portion of the insulating body, for example in the form of a transverse web, between the supporting areas so that a portion of a surface of the insulating body extends between the supporting areas. The supporting areas of one and the same supporting region may be connected to one another in an electrically conducting manner, for example by way of a main body that connects them at a fixed angle and is at least partially embedded in the insulating body.

Furthermore, it may it be advantageously provided that the insulating body is a rotationally symmetrical body, in particular a hollow body.

A rotationally symmetrical body on the one hand has a fixed-angle structure requiring little material to be used, on the other hand rotationally symmetrical bodies can be kept free from projecting edges, so that the insulating body is designed dielectrically favorably and excessive field intensities of an electrical field are avoided. In addition, the use of a hollow body makes an additional reduction in the mass possible. In particular, with a coaxial arrangement of a main body in the form of a segment of a ring or in the form of a full ring in relation to the axis of rotation of the insulating body, additional stabilization of the support insulator assembly can be brought about. Furthermore, it may be provided for subassemblies to be fed in through a clearance on a hollow body or for subassemblies to be arranged in the clearance. For example, the clearance in a hollow body may be passed through by a drive rod that can be moved in relation to the support insulator assembly. The armature bodies may be arranged in particular at the end faces on a rotationally symmetrical insulating body, so that first and second supporting regions are arranged on the end faces of sides of a rotationally symmetrical body that are opposite from one another. Advantageously, it may also be provided that the insulating body is a frustum of a cone, in particular a frustum of a hollow cone.

Frustoconical forms are suitable in particular for providing supporting regions on their end faces. Planar supporting regions can preferably be provided on the end faces of the frustums of a cone, with an electrically insulating portion arranged between them in the direction of the axis of rotation of the frustum of a cone. A frustoconical form additionally has the effect of extending the length of the creepage path between the two supporting regions on the surface of the insulating body in comparison with a cylindrical shape of the insulating body. In this way, the support insulator assembly has an increased dielectric loading capacity.

It may advantageously also be provided in this case that the two supporting regions are arranged at end faces on the insulating body.

An end-face arrangement of the two supporting regions makes it possible to align the supporting regions on the insulating body in oppositely directed senses. When a rotationally symmetrical insulating body is used, the supporting regions may for example be aligned coaxially in relation to one another, the end-face areas for example having differing cross sections when a frustoconical insulating body is used, so that armature bodies that differ from one another in their dimensions have to be provided. The armature bodies are however similar in this case.

Furthermore, it may be advantageously provided that the main body has running around the inner circumferential side and/or the outer circumferential side a profiling that increases the surface area.

A profiling that increases the surface area serves for an improved connection of the insulating body to the armature body. Thus, the surface area available for a material bond is increased. Furthermore, a form fit between the insulating body and the armature body can be additionally brought about. Of advantage in particular as the profiling are designs that do not have sharp body edges, so that the risk of excessive field intensities is reduced. For example, the main body may have undulating surface regions. A rotationally symmetrical profiling of the surface of the main body proves to be advantageous. The main body may for example have a cross section of a constricted ring. For example, it may be envisaged to provide the main body with grooves running around uninterruptedly on the inner and/or outer circumferential sides.

A cross section of a constricted ring has the effect of additionally increasing the cross section in its outer surface area in comparison with a circular, rectangular, etc. cross section of a ring. Furthermore, the larger surface region makes the embedding more easily possible, so that it is made more difficult for the main body to tilt or break out from its embedding. A constriction may be formed for example by grooves that run uninterruptedly around the ring axis being formed on the inner and outer circumferential sides of the ring-shaped main body. The grooves may be aligned oppositely, while the grooves should have similar cross sections. For example, a groove may have a rectangular profile, a half-round profile, a dovetail profile, etc.

A further advantageous configuration may provide that the supporting area is an end face of an elevation formed on the main body, in particular a cylinder.

A main body has a ring-shaped structure or a segment of a ring-shaped structure. The main body has a corresponding cross section, it being possible for an elevation, for example a cylinder, to be formed on a surface of the main body, the cylinder rising up from the main body and a main area being formed on the end face of the cylinder. A vertical axis of an elevation, for example the cylinder axis, and the ring axis should be aligned at least approximately parallel. The elevation may have various kinds of top areas. For example, the top areas may be fashioned in the form of a ring, half a ring, a third of a ring, a circle, a rectangle, a kidney, etc. The top area may be at least part of a supporting area. It is possible by way of the formed-on elevation not only that the supporting areas pass through a surface of the insulating body but are also allowed to protrude beyond this surface. The elevation forms a projecting shoulder in the surface of the insulating body.

A further advantageous configuration may be provided by an interrupter unit of an electrical switching device being supported with respect to an encapsulating housing by way of the support insulator assembly.

An encapsulating housing serves for shock protection of electrically active phase conductors of an electrical switching device. The encapsulating housing also protects the electrical switching device mechanically. In particular, the encapsulating housing may also be formed as an explosion-proof encapsulation, i.e. the encapsulating housing is a pressure vessel that is filled in its interior with a fluid under positive pressure, in particular an electrically insulating gas. Arranged within the encapsulating housing is an interrupter unit of an electrical switching device, the interrupter unit being immersed in an electrically insulating fluid. In order to keep the interrupter unit at a distance from the encapsulating housing, a support insulator assembly may be used, the support insulator assembly serving for holding the interrupter unit of the circuit breaker in an electrically insulated manner with respect to the encapsulating housing. By way of the support insulator assembly, subassemblies, here the interrupter unit and the encapsulating housing, are positioned at a fixed angle in relation to one another and kept at a distance from one another in an electrically insulated manner. Correspondingly, the support insulator assembly is exposed to an electrical field inside the encapsulating housing.

The encapsulating housing may be for example an electrically insulating housing or else an electrically conductive housing that is at ground potential for example. Consequently, the subassemblies of an electrical switching device that are subjected to increased electrical potential are positioned at a distance in relation to the encapsulating housing, allowing the difference in potential to be reduced along a path between the supporting regions of the support insulator assembly. Correspondingly, the electrically insulating material of the insulating body is subjected to electrical loading and is additionally loaded by cantilever forces, which may for example originate from the weight of the interrupter unit of the circuit breaker or else be produced by electrodynamic loads, for example as a consequence of short-circuits.

An exemplary embodiment of the invention is described in more detail below and shown schematically in the drawing, in which:

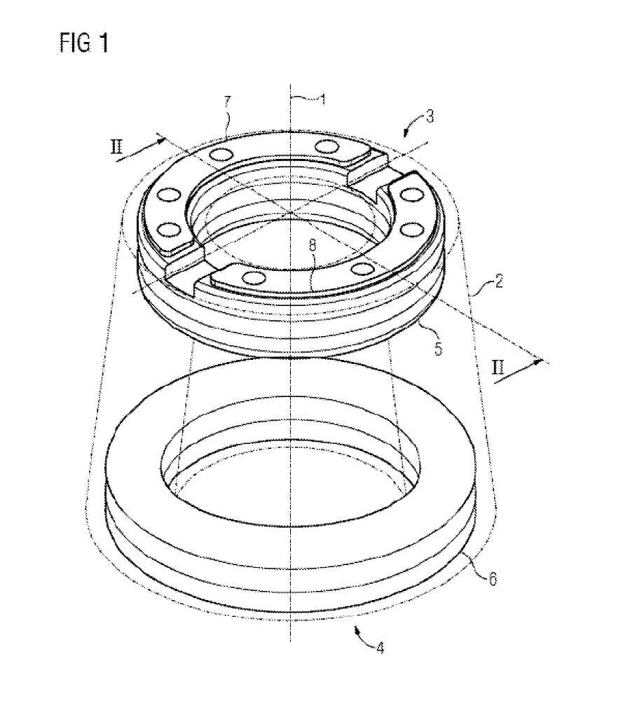

FIG. 1 shows a perspective view of a support insulator assembly,

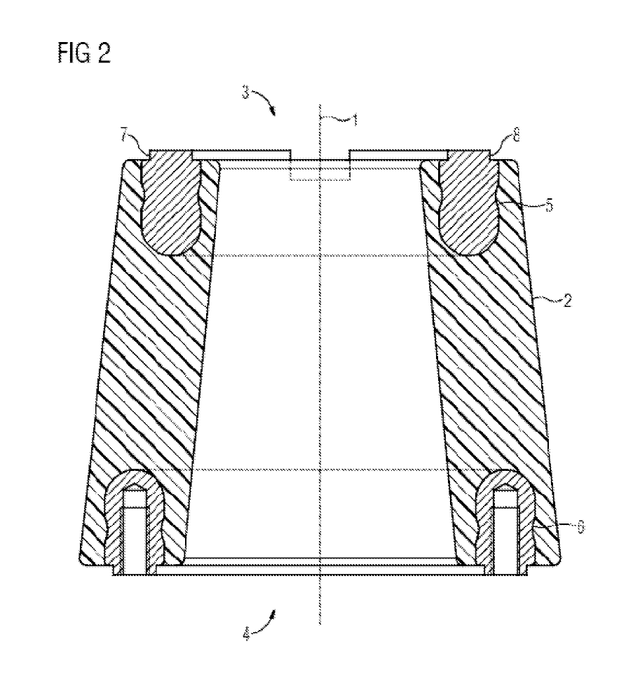

FIG. 2 shows a section through the support insulator assembly known from FIG. 1, and

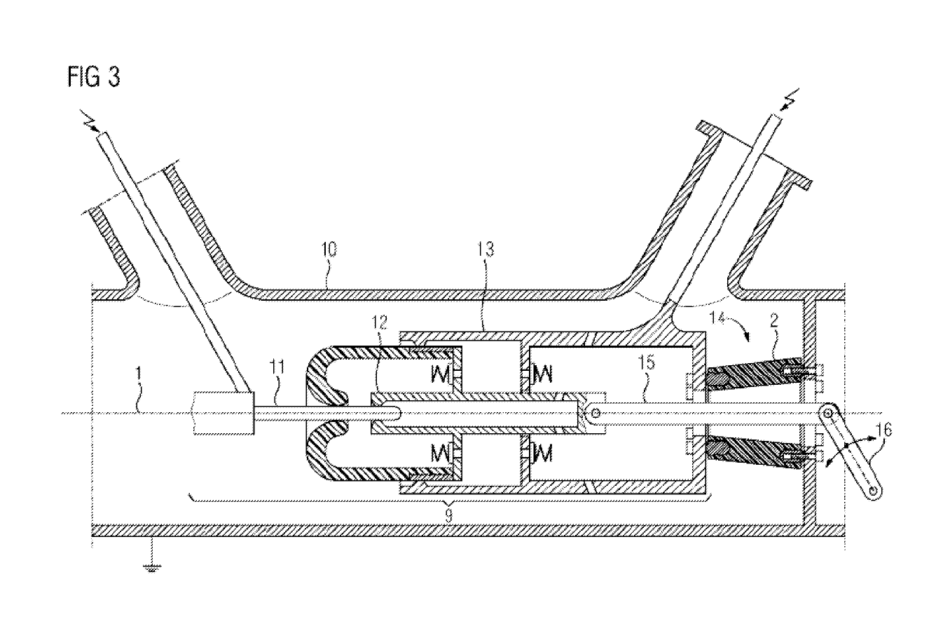

FIG. 3 shows a use of the support insulator assembly known from FIGS. 1 and 2 within an encapsulating housing.

FIG. 1 shows a perspective view of a support insulator assembly, which extends coaxially in relation to an axis of rotation 1. The support insulator assembly has an insulating body 2, which is for example fashioned as a cast resin insulating body. The insulating body 2 has a rotationally symmetrical shaping, in the present case in the form of a frustum of a hollow cone. The support insulator assembly has a first supporting region 3 and a second supporting region 4. The first supporting region 3 is arranged on a first end face of the insulating body 2. The second supporting region 4 is arranged on a second end face of the insulating body 2. The two supporting regions 3, 4 are directed oppositely from one another, the two supporting regions 3, 4 forming surfaces on the insulating body 2 that are substantially in the form of a circular ring.

In a way corresponding to the hollow frustoconical shape of the insulating body 2, the first supporting region 3 has a smaller cross section than the second supporting region 4, the two supporting regions 3, 4 resembling one another.

Inserted in the first supporting region 3 is a first main body 5 of a first armature body. Inserted in the second supporting region 4 of the insulating body 2 is a second main body 6 of a second armature body. Both main bodies 5, 6 are embedded in the insulating body 2 and have the structure of a full ring. The two main bodies 5, 6 are part of a first and a second armature body, the main bodies 5, 6 being respectively completed by formed-on elevations in the form of cylinders, the cylinder axes of which are aligned substantially parallel to the axis of rotation 1. The main bodies 5, 6 are aligned with their ring axes coaxially in relation to the axis of rotation 1.

By way of example, the fashioning of the formed-on cylinders is described on the basis of the first supporting region 3, which can be seen in plan view in FIG. 1. The first main body 5 with its ring-shaped structure is arranged coaxially in relation to the axis of rotation 1. Formed on the first main body 5 are a first cylinder 7 and a second cylinder 8. The two cylinders 7, 8 respectively have end faces, which have the form of a segment of a circular ring. In this case, the end faces are aligned coaxially in relation to the axis of rotation 1 and act as supporting areas arranged within an enveloping contour of a circular ring. Thus, arranged in the first supporting region 3 of the support insulator assembly is a first armature body, which has a first and a second supporting area that pass independently of one another through a surface of the insulating body 2. In this case there is respectively on/in the two supporting areas a step to the surface surrounding them of the insulating body 2. Consequently, the supporting areas not only pass through the surface of the insulating body 2. The supporting areas even protrude beyond the surface of the insulating body 2.

The cylinders 7, 8 are arranged with their supporting areas at a distance from one another, so that between the cylinders 7, 8 there remain transverse webs filled with insulating material separating the two supporting areas from one another, the two supporting areas together lying within an enveloping contour of a circular ring. The transverse webs are arranged substantially radially, passing through the enveloping contour of the supporting areas that is in the form of a circular ring.

The first and second cylinders 7, 8 are fixed on one and the same first main body 5, so that the two cylinders 7, 8 are fixed in their position in relation to one another. Furthermore, a number of symmetrically distributed threaded bores acting as attachment points open out into the supporting areas of the first and second cylinders 7, 8. The threaded bores extend into the cylinders and into the main body, so that screwing of the subassemblies to be supported can be performed here. The threaded bores are arranged within the armature body and are dielectrically shielded by it. The threaded bores serve as attachment points, in order to fix a subassembly on the insulator assembly.

The end face of the insulating body 2 that is concealed in FIG. 1 is fashioned in an analogous way, with the second armature body embedded there. In a way corresponding to the increased cross section of the second supporting region 4 in relation to the first supporting region 3, larger supporting areas are obtained on the second main body 6.

FIG. 2 shows a section through the axis of rotation 1, so that the cross section of the main bodies 5, 6 can be seen. The ring-shaped main bodies 5, 6 respectively have a constricted cross section, grooves aligned equally and oppositely and running around uninterruptedly being formed on the inner and outer circumferential sides of the main bodies 5, 6. In this way, the surface area within the embedded portions of the armature bodies is increased, so that the armature bodies are fixed within the insulating body 2 in an improved way. For embedding the armature bodies, it is envisaged to encapsulate the armature bodies with the insulating material of the insulating body 2 in the fluid state. The main bodies are advantageously embedded completely in the insulating body 2. The cylinders 7, 8 of the armature bodies protrude from the insulating body. It can also be seen in FIG. 2 how the cylinders 7, 8 rise up from the first main body 5 and pass through a surface of the insulating body 2. Supporting areas that have structures in the form of half rings are formed. No threaded bores can be seen in section in the first main body 5 on account of the position of the sectional plane in FIG. 2. Threaded bores in the respective cylinders that bear the supporting areas and keep them at a distance from the insulating body 2 are represented in section on the second main body 6. The threaded bores extend into the ring-shaped main body 6.

The use of a support insulator assembly according to the invention on an electrical switching device is described in more detail on the basis of FIG. 3. FIG. 3 shows a section through an electrical switching device, the electrical switching device having an interrupter unit 9, which is arranged inside an encapsulating housing 10. The encapsulating housing 10 is only represented here in the form of a detail, the encapsulating housing 10 being fashioned as a pressure vessel in the form of a metal housing. The interior of the encapsulating housing 10 is filled with an electrically insulating gas, for example sulfur hexafluoride. The encapsulating housing 10 preferably encapsulates the electrically insulating gas hermetically.

The interrupter unit 9 of the electrical switching device has a first contact piece 11 that is fixed in place and a second contact piece 12 that is movable in relation to the fixed first contact piece 11. The fixed first contact piece 11 is fashioned in the form of a bolt, the longitudinal axis of the first contact piece 11 in the form of a bolt being arranged coaxially in relation to an axis of rotation 1. The second contact piece 12 is fashioned in a hollow-cylindrical manner, so that a bush is formed at its end toward the first contact piece 11. The interrupter unit has a chassis 13, within which the second contact piece 12 can be displaced along an axis of rotation 1 of the interrupter unit 9. The chassis 13 is supported at a fixed angle on the encapsulating housing 10 and serves for electrical contacting of the second contact piece 12. For supporting the chassis 13 at a fixed angle, a support insulator assembly 14 that is shown in FIGS. 1 and 2 is used. The support insulator assembly 14 is aligned with its axis of rotation 1 coaxially in relation to the axis of rotation 1 of the interrupter unit 9 according to FIG. 3.

In order to transfer a linear movement to the movable second contact piece 12, a connecting rod 15 is coupled to the movable second contact piece 12. At the end of the connecting rod 15 that is remote from the movable contact piece 12, a pivotable lever 16 is connected to the connecting rod 15, so that a pivoting movement of the lever 16 can be transformed by the connecting rod 15 into a linear movement of the movable second contact piece 12.

The connecting rod 15 passes centrally through the support insulator assembly 14. On account of the configuration of the support insulator assembly 14 with an insulating body in the form of a hollow cone, there is the possibility of allowing the connecting rod 15 to be deflected within the support insulator assembly 14 as a result of excessive travel of the lever 16 without the connecting rod 15 coming into direct contact with the insulating body 2 of the support insulator assembly 14.

1-15. (canceled)

16. A support insulator assembly, comprising:
an electrically insulating insulator body;
a first supporting region and a second supporting region, spaced apart from one another and kept at a distance by said insulator body;
said first supporting region having an armature body that is at least partially embedded in said insulator body.

17. The support insulator assembly according to claim 16, wherein said armature body of said first supporting region is a first armature body and said second supporting region has a second armature body that is at least partially embedded in said insulator body.

18. The support insulator assembly according to claim 16, wherein said armature body comprises a main body formed of at least one segment of a ring.

19. The support insulator assembly according to claim 18, wherein said armature body is formed as a full ring.

20. The support insulator assembly according to claim 18, wherein said armature body has at least one supporting area aligned transversely in relation to a ring axis of said main body and passing through a surface of said insulator body.

21. The support insulator assembly according to claim 18, wherein said supporting area is aligned perpendicularly relative to the ring axis of said main body.

22. The support insulator assembly according to claim 20, wherein said armature body has at least first and second attachment points that are fixed at a fixed angle relative to one another by said main body.

23. The support insulator assembly according to claim 20, wherein said armature body has two supporting areas which pass independently of one another through a surface of said insulator body and which are connected by said main body.

24. The support insulator assembly according to claim 20, wherein a respective said supporting area corresponds at least to a sector of a circular ring.

25. The support insulator assembly according to claim 24, wherein the respective said supporting area corresponds to a complete circular ring.

26. The support insulator assembly according to claim 20, wherein a number of supporting areas lie within an enveloping contour of a circular ring.

27. The support insulator assembly according to claim 26, wherein said supporting areas lie spaced from one another in a surface of said insulator body.

28. The support insulator assembly according to claim 16, wherein said insulator body is a rotationally symmetrical body.

29. The support insulator assembly according to claim 28, wherein said insulator body is a hollow body.

30. The support insulator assembly according to claim 28, wherein said insulator body is a frustum of a cone.

31. The support insulator assembly according to claim 30, wherein said insulator body is a frustum of a hollow cone.

32. The support insulator assembly according to claim 16, wherein said first and second supporting regions are respectively arranged at end faces on said insulator body.

33. The support insulator assembly according to claim 18, wherein said main body is formed with a profiling running around an inner periphery and/or an outer periphery for increasing a surface area.

34. The support insulator assembly according to claim 20, wherein said supporting area is an end face of an elevation formed on said main body.

35. The support insulator assembly according to claim 16, disposed to support an interrupter unit of an electrical switching device with respect to an encapsulating housing.
